(19) United States
(12) Patent Application Publication
(10) Pub. No.: US 2023/0265709 A1
(43) Pub. Date: Aug. 24, 2023

(54) BULLET-RESISTANT DOOR

(71) Applicant: Brentwood Manufacturing Company, Inc., Pomona, CA (US)

(72) Inventors: Drew Joseph Andary, Anaheim, CA (US); Fred Joseph Andary, JR., Yorba Linda, CA (US)

(21) Appl. No.: 17/652,459

(22) Filed: Feb. 24, 2022

(51) Int. Cl. E06B 5/10; E06B 3/82; E06B 3/70; F41H 5/24

(52) U.S. Cl. CPC E06B 5/10; E06B 3/7015; E06B 3/825; F41H 5/24; E06B 2003/7051; E06B 2003/7061

(57) ABSTRACT

A bullet-resistant door includes a wooden frame forming a perimeter structure and protective layers that are collectively secured within the wooden frame. Such protective layers include: bullet-resistant panels that are made of a base material having embedded fibrous material and that are at least semi-rigid; and bullet-resistant sheets of a woven high-strength pliable fabric. In addition, a substantially hollow core that is at least ½ inch thick is provided between the protective layers

### FIELD OF THE INVENTION

The present invention pertains, among other things, to bullet-resistant doors, particularly lightweight doors, as well as to methods and techniques for producing such doors.

### BACKGROUND

The following discussion concerns some of the prior art that is relevant to the present invention, together with its the present inventor’s observations regarding, and characterizations of, such prior art, based on the inventor’s ongoing work and analysis of such prior-art structures. Only knowledge explicitly described in the following discussion as being “conventional” or “prior art” is intended to be characterized as such.

With the proliferation of gun-related crimes, people have become more and more interested in protective measures. One such measure is a door that can resist penetration by bullets. By having and using such a door, people typically can be better protected against home invasions, mass shootings, etc.

A variety of different bullet-resistant doors have been produced. However, many of such doors are very heavy (often made of steel) and, therefore, not very practical for everyday use. In fact, installation of such conventional security doors often has required special tools and, often, even reconstruction of the existing doorways in order to support the additional weight. Moreover, such structures often limit the kinds of locking mechanisms and other hardware that can be used, e.g., due to their weight and/or the volume of protective material that they are required to include.

Some lighter-weight doors also have been sold. In fact, the present applicant has sold a number of lightweight security doors over the years. However, improvements in the designs of such existing lighter-weight doors are desirable, particularly in connection with improving the trade-off between the degree of protection provided and the weight of the door, i.e., allowing for better strength-to-weight ratios in relation to penetration from a variety of different kinds of bullets.

### SUMMARY OF THE INVENTION

The present invention addresses this need, e.g., by providing new designs in which particular layers and/or sequences of layers of materials are employed in order to provide better protection with lower overall weight.

Thus, one embodiment of the invention is directed to a bullet-resistant door that includes a wooden frame forming a perimeter structure and protective layers that are collectively secured within the wooden frame. Such protective layers include: bullet-resistant panels that are made of a base material having embedded fibrous material and that are at least semi-rigid; and bullet-resistant sheets of a woven high-strength pliable fabric. In addition, a substantially hollow core that is at least ½ inch thick is provided between the protective layers.

One particular door structure according to the present invention (currently sold as the Garrison model by the Applicant) already has been designated as satisfying the UL 752 Level Three ballistic protection standard, using a combination of two ballistic fiberglass bullet-resistant panels, multiple layers of Kevlar™, a cellular hollow door core and a mixture of catalyst and fire-resistant glue. Such a structure’s unique interior design has built-in buffering capabilities to disperse the energy opening coming bullet, and offers the flexibility of various hardware installations and locking options that generally cannot be easily accomplished when using other security doors on the market.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the accompanying drawings. However, it should be understood that the drawings merely depict certain representative and/or exemplary embodiments and features of the present invention and are not intended to limit the scope of the invention in any manner. The following is a brief description of each of the accompanying drawings.

FIG. 1 is an exploded perspective view showing certain layers of a bullet-resistant door according to a representative embodiment of the present invention.

FIG. 2 is an enlarged rear perspective view of the door’s frame, the front perspective view being identical.

FIG. 3 is a rear elevational view of the door.

FIG. 4 is a sectional view of the door taken on line 4-4 of FIG. 3.

FIG. 5 is a sectional view of the door taken on line 5-5 of FIG. 3.

FIG. 6 is a rear perspective view of the completed door.

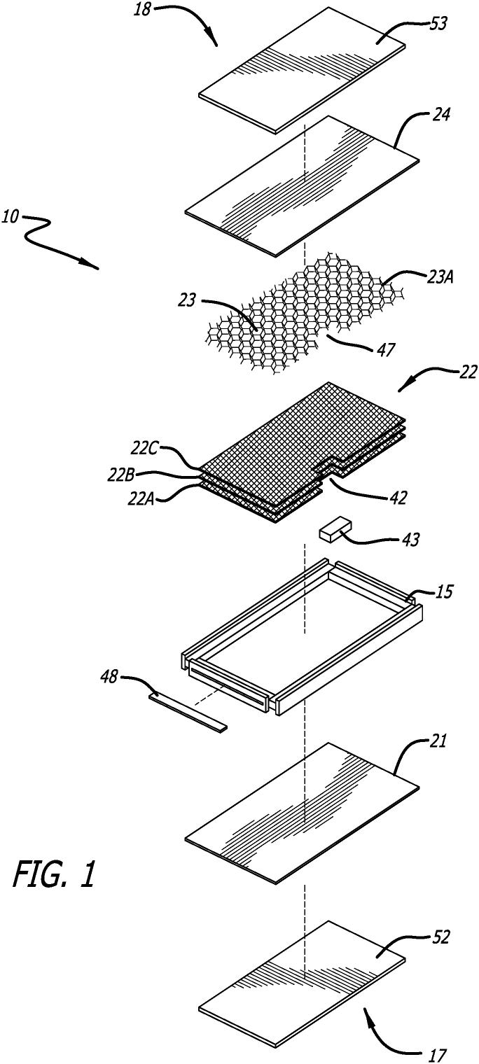

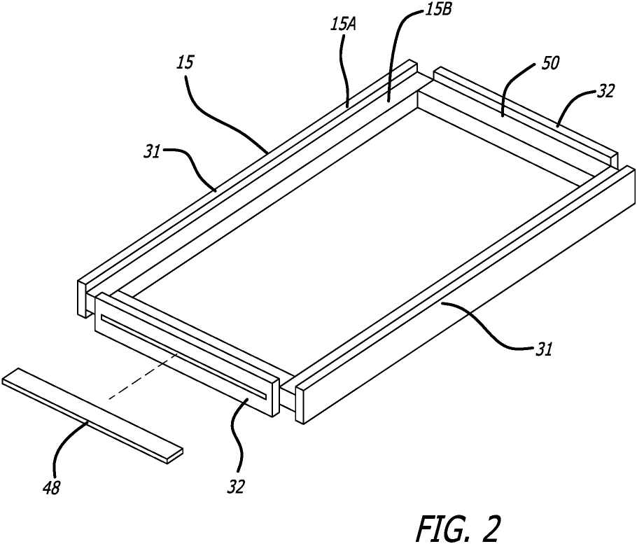

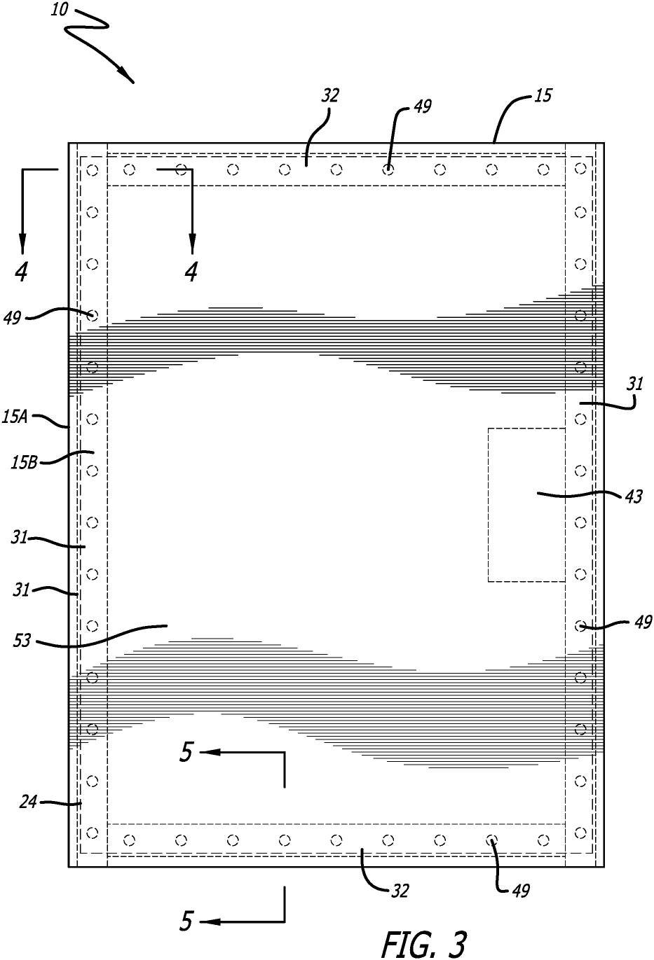

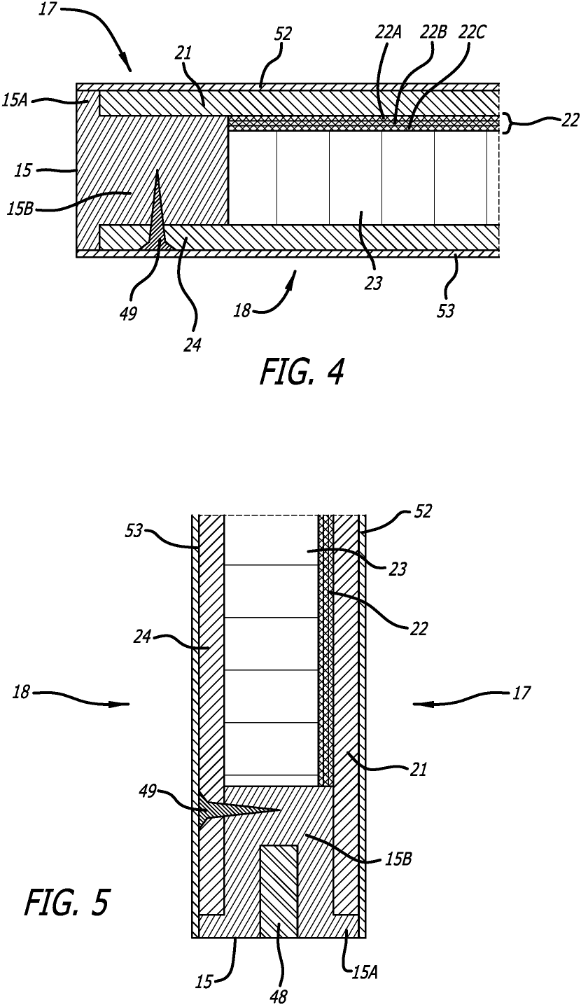

### DESCRIPTION OF THE PREFERRED EMBODIMENT(S)

For ease of reference, the present disclosure is divided into sections. The general subject matter of each section is indicated by that section’s heading. However, such headings are included simply for the purpose of facilitating readability and are not intended to limit the scope of the invention in any manner whatsoever.

### Representative Doors

The main structural components of a representative door 10 according to the present invention are illustrated in the accompanying drawings. As shown, door 10 includes a frame 15 and a number of protective layers that are collectively secured within frame 15. In the current embodiment, such layers include, arranged in order, through the depth or thickness of the door 10, from a front (or attack) side 17 of the door 10 to a rear (or protected) side 18 of the door 10: (1) a protective bullet-resistant panel 21; (2) one or more, preferably multiple, bullet-resistant sheets 22 of a woven high-strength pliable fabric; (3) a substantially hollow core 23; and (4) another protective bullet-resistant panel 24. In addition to such protective layers, door 10 preferably includes a front skin 52 and a rear skin 53. Each of the foregoing components is described in more detail below. Unless indicated otherwise in the following description, when measurements are given for a particular dimension of a specified component, such dimensions correspond the dimensions of the door 10, i.e., thickness pertains to the dimension in which the thickness of the door 10 is measured, width pertains to the dimension in which the width of the door 10 is measured, and length pertains to the dimension in which the height of the door 10 is measured.

Frame 15 preferably is made of wood and, more preferably, maple or another hardwood. In the preferred embodiments, e.g., for the reasons indicated below, frame 15 includes an outer portion 15A and an inwardly extending portion 15B. Outer portion 15A preferably is between 1 ½ - 2½ inches thick, and more preferably, a little more than approximately 1 ½ inches thick (in the current specific embodiment, 1.5 - 1.7 inches thick). Inwardly extending portion 15B preferably is between ¾ - 1 ¼ inch thick, and more preferably, 0.85 - 1.0 inch thick. Stated in different terms, inwardly extending portion 15B preferably is between 40-80%, and more preferably 55-65%, of the thickness of frame 15 and/or outer portion 15A. In any event, again for the reasons explained in more detail below, outer portion 15A preferably is substantially thicker than inwardly extending portion 15B, so as to form front and rear rabbets. In the specific current embodiment, frame 15 is comprised of left and right side stiles 31 and top and bottom edge rails 32, each made of 3-ply maple or another hardwood and having the described rabbeted structure, and all bonded together at the corners. In the current specific embodiment, frame 15 is approximately 83-84 inches high and approximately 35-36 inches wide. The outer portion 15A initially is approximately ½ inch wide (after trimming the door, reduced to approximately ¼ inch wide), and the inwardly extending portion 15B is approximately 1 ¾ inches wide (with respect to both, the width measurement being in the width dimension of the door 10 for stiles 31 and being in the height dimension of the door 10 for rails 32).

Primarily because door 10 is intended to be used interchangeably with conventional wooden doors, door 10 preferably has an overall thickness of approximately 1.7 - 1.9 inches (in the current specific embodiment, a thickness of 1.82 inches), a height of at least 78 inches and, more preferably 80-84 inches (in the current specific embodiment, a height of approximately 83-84 inches), and a width of at least 32 inches and, more preferably, approximately 35-36 inches.

Protective panels 21 and 24 preferably are made of a base material that has embedded fibrous material (i.e., individual fibers, such as fiberglass, or material made from fibers), and more preferably, fibers that have been woven or otherwise formed into fabric material. In the preferred embodiment, the fibers are woven-roving fiberglass, and such material is embedded within, and provides reinforcement for, a base material of thermoset resin. In the preferred embodiments, panels 21 and 24 are UL 752 certified bullet resistant fiberglass panels, with a combined thickness of at least 0.55-0.65 inch (e.g., each preferably at least 0.27 - 0.33 inch thick, and more preferably, each approximately 0.3 inch thick). In addition, panels 21 and 24 preferably are at least semi-rigid, i.e., either semi-rigid (e.g., stiff and solid, but having at least some noticeable flexibility) or fully rigid (e.g., stiff and solid without noticeable or visible flexibility). In the currently preferred embodiment, each of such panels 21 and 24 is a 0.3 inch thick ArmorCore® bullet-resistant panel, sold by Waco Composites™.

As discussed in greater detail below, panels 21 and 24 preferably are bonded into the rabbeted portions of frame 15 (more preferably, bonded to inwardly extending portion 15B). In addition, panel 24 preferably is attached to inwardly extending portion 15B using a plurality of screws 49 around its entire perimeter. This additional feature has been found to provide better protection in the event of multiple gunshots, as well as better securing protective panel 24 and helping to prevent blowing off and spraying of debris into the space on the protected side 18 of the door 10.

Although two such protective panels (i.e., panels 21 and 24) are provided in the current embodiment, in alternate embodiments any number panel(s) instead may be used, and when multiple panels are used, they can have the same or different thicknesses. However, the present inventor has found that the present configuration of panels 21 and 24 separated by multiple sheets 22 of a woven high-strength pliable fabric and hollow core 23 provides a good solution for disrupting and, ultimately, helping to stop, the energy of a bullet.

In the current embodiment, three sheets 22 of a woven high-strength pliable fabric (i.e., sheets 22A-C), which collectively are approximately 1/16 inch thick, are layered immediately behind the protective panel 21 (immediately adjacent to each other, on attack side 17, such protective panel 21). While this configuration currently is preferred, in alternate embodiments, a different number and/or arrangement of such sheets 22 is used.

Preferably, sheets 22 are made of a synthetic aromatic polyamide polymer, and more preferably, are made of poly-para-phenylene terephthalamide. In the current embodiment, sheets 22 are made from 1006 KV K29 Kevlar™ by DuPont™ that has been woven into 3000D sheets by Barrday™.

To further enhance the protection afforded by sheets 22, the frontmost sheet 22A is securely bonded into place (i.e., glued or otherwise bonded to the back surface of protective panel 21 in the present embodiment), while the other sheets (sheets 22B and 22C in the present embodiment) are entirely or substantially (e.g., across at least 70-80% of its surface area) unattached, e.g., just laid in and held in place solely by virtue of pressure from adjacent components. In the current embodiment, the present inventor has found that such a configuration, which provides an ability for sheets 22B and 22C to move and/or give in response to the impact of a bullet, provides additional protection. As noted, sheets 22B and 22C are completely unattached in the current embodiment; however, acceptable results might be achieved if minimal attachment (e.g., points around the sheets’ peripheries) is used, e.g., in alternate embodiments.

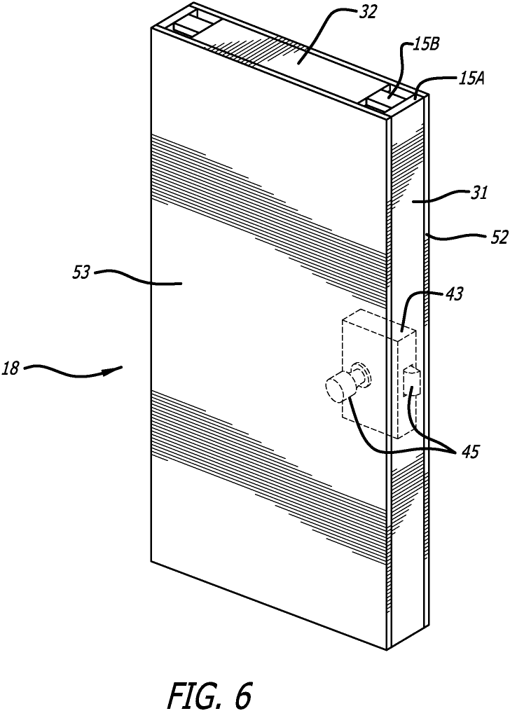

As shown, sheets 22 are not entirely rectangular, but instead have been precut so as to have an opening 42, which matches the cross-section of an inserted block 43. In the preferred embodiments, block 43 is inserted to hold space for a doorknob/lock mechanism 45 (shown in phantom in FIG. 6), which can be attached, e.g., by the end user or a downstream worker after the door 10 leaves the manufacturing facility. One benefit of including such a block 43 is that it ensures the sheets 22 do not encroach into that space. Without it, there is a greater risk that the fibers of sheets 22 will get caught in the bit and/or blade of one of the tools used to install such doorknob/lock mechanism 45, potentially displacing one or more of such sheets 22. Preferably, block 43 is made of a soft, lightweight material, such as Styrofoam™ or another form product. Although only a single block 43 is shown in the drawings and employed in the present embodiment, any number of such blocks may be used in alternate embodiments, e.g., to additionally hold space for a vision light or any other feature(s) to be included within the door 10 (e.g., for the purposes noted above).

One unique feature of door 10, which is made possible by its inventive structure, is the existence of a substantially hollow core 23. As indicated above, door 10 is much thinner than other conventionally available bullet-resistant doors, preferably not more than two inches thick, i.e., within the range of the thicknesses of conventional ordinary (non-bullet-resistant) wooden doors. Nevertheless, in this confined space, the other structure of the present door 10 allows for the existence of substantially hollow core 23, thereby allowing for a greater range of options in terms of locking mechanisms that may be used, provision of internal wiring, etc. Preferably, substantially hollow core 23 is between ¾ - 1 ¼ inch thick, and more preferably, approximately 1 inch thick (15/16 inch in the specific present embodiment). Stated in other terms, substantially hollow core 23 preferably is between 40-60%, and more preferably approximately 50%, of the thickness of door 10.

In the current embodiment, the interior space for substantially hollow core 23 is held by the use of a honeycomb cellular structure 23A, which typically can provide uniform structural support. Preferably, honeycomb structure 23A is made of cardboard (in the current specific embodiment) or fiberboard. As shown, honeycomb structure 23A has substantially flat front and rear sides, with a network of flat strips extending through its thickness and crisscrossing each other in two dimensions. In the present embodiment, that network of strips is arranged largely randomly, due to the manner in which it is inserted within door 10 (as discussed in greater detail below); however, in alternate embodiments, a regular crisscrossing pattern is used. In any event, the majority of the space occupied by substantially hollow core 23 (e.g., at least 70-80%) preferably is empty. Use of cardboard (which is flexible and easily displaced) for honeycomb structure 23A typically can allow for easier and more customizable use of substantially hollow core 23. In alternate embodiments, different structures are used within substantially hollow core 23, e.g., depending upon the intended use of core 23, such as structure that provides conduit(s) for desired wiring. In still further alternate embodiments, substantially hollow core 23 is made of foam. Similar to sheets 22, honeycomb structure 23A preferably includes a notch 47 to accommodate block 43 (and additional notch(es) to accommodate any additional block(s) used, as noted above). Although shown as one piece, honeycomb structure 23A instead typically will be multiple separate pieces that are simply spread out around the block 43 within the interior space defined by the innermost edge 15C of inwardly extending portion 15B.

Preferably, both substantially hollow core 23 and sheets 22 are interior to innermost edge 15C of inwardly extending portion 15B of frame 15 and, collectively, are approximately as thick as such innermost edge 15C (i.e., occupying the same thickness range of door 10). For instance, in their present embodiment, innermost edge 15C is 1 inch thick, and the combination of hollow core 23 (15/16 inch thick) and sheets 22 (1/16 inch thick) also is 1 inch thick, so that the surfaces of inwardly extending portion 15B, on one hand, and the combination of hollow core 23 and sheets 22, on the other, are at least approximately even with (i.e., at approximately the same depth as) each other.

In the current embodiment, a bullet-resistant elongated strip 48 is provided along the bottom edge of the door 10 to provide even more protection. Preferably, strip 48 is made of the same material as protective panels 21 and 24, or at a minimum, the considerations with respect to the choice of materials for strip 48 are the same as described above in connection with panels 21 and 24. Strip 48 preferably a 0.4-0.6 inch thick and, in the current specific embodiment, is ½ inch thick. Preferably, its length is at least 70-90% of the width of the door 10 or at least 24 inches, and it is 0.8-1.2 inches wide (approximately 1 inch wide in the current specific embodiment).

Finally, door 10 is provided with a skin 52 on its front side 17 and another skin 53 on its rear side 18. In the current embodiment, skins 52 and 53 are identical to each other. Each preferably includes 2.33 millimeter (mm) thick high-density fiberboard (HDF) covered by a decorative veneer (on the exposed side) that brings the total thickness to 2.8 mm (or 0.11 inch). Preferably, the decorative veneer matches the wood used for frame 15.

A door according to the present invention typically can be made without any (or at least any significant) protective layers made of steel. As a result, such a door often will be much lighter than conventional bullet-resistant doors, while still providing excellent protection. In fact, a door according to the present invention often can be used to replace a non-security wooden door, with no (or relatively minor) alterations to the door frame (i.e., the portion of the structure’s wall that surrounds the door 10, as opposed to the frame 15 of the door 10 itself).

### Manufacturing Methods

The following discussion concerns certain representative processes for manufacturing a door 10 according to the present invention, focusing primarily on the currently preferred process.

As noted above, each of protective panels 21 and 24 preferably is 0.3 inch thick when used. Initially, however, each preferably is thicker (e.g., 0.312 inch thick), and prior to use, it is first sanded down in order to rough it up so that the glue will stick better to it, resulting in the final desired thickness.

Following that initial step, glue is applied to the front surface of inwardly extending portion 15B. Then, such surface is pressed together with the perimeter of the rear side of protective panel 21, so as to bond protective panel 21 to such surface. Preferably, the glue is applied to such surface while frame 15 is laying flat (e.g., on top of protective panel 21), with its front surface facing upwardly, and then frame 15 is flipped over onto protective panel 21, so that the weight of frame 15 maintains pressure on the bond between the two components, while at the same time, also exposing the rear side of frame 15 for performing the additional steps described below.

As indicated in the drawings, protective panel 21 preferably is just slightly smaller than the peripheral rabbet formed by outer portion 15A and inwardly extending portion 15B on the front (or attack) side 17 of frame 15. Such a close fit can provide for a more secure attachment. When placed within such peripheral rabbet, the front surface of protective panel 21 preferably is approximately flush with the front surface of outer portion 15A of frame 15.

In the present discussion, when glue is referenced as being used to bond two components together, such glue preferably is a mixture that includes IFS adhesive G-2360 SP, combined with one or more catalysts such as IFS CS-1002 and/or IFS G-1678, all made by IFS Industries Inc.

With the frame 15 turned over, as described above, glue is applied to the portion of the rear surface of protective panel 21 that is interior to the innermost edge 15C of inwardly extending portion 15B. Then, a block 28 (used to hold space for a lock that can be subsequently installed) and/or any other blocks (to hold space for any other component subsequently to be installed) is/are placed at appropriate location(s). In the present embodiment, block 28 and any such other block(s) are made of Styrofoam™. However, any other material (preferably one that it is lightweight and/or can be easily removed when desired) can be used in alternate embodiments. The present discussion assumes use of a single block 28, but the same considerations apply if any other block(s) are used.

Thereafter, sheet 22A of the woven high-strength pliable fabric (previously cut to fit within the perimeter defined by innermost edge 15C and to include opening 42) is pressed onto the foregoing glued portion of the rear surface of protective panel 21, with opening 42 accommodating block 28. Then, sheet 22B (also previously similarly cut) is laid on top of sheet 22A, and sheet 22C (also previously similarly cut) is laid on top of sheet 22B, in each case without using any glue, so that, ultimately, sheets 22B and 22C preferably are held in place solely, or almost entirely, as a result of pressure from the adjacent components. Once again, in the current embodiment, each of sheets 22A-C is identical to the others and has been precut so as to: (1) have an opening 42 where block 28 is located and (2) fit within and closely conform to the innermost edge 15C of inwardly extending portion 15B.

Following placement of sheets 22, honeycomb structure 23A, which previously has had its front and rear sides coated with glue is placed on top of the rearmost sheet 22C. In this regard, as noted above, honeycomb structure 23A is made of cardboard in the present embodiment. Preferably, sections of honeycomb structure 23A initially are collapsed together into bundles, at which point glue has been applied to the front and rear sides. Then, the bundles are expanded and placed on top of rearmost sheet 22C, within the boundary defined by innermost edge 15C of inwardly extending portion 15B and around block 28. After completion of this step, the rear side of honeycomb structure 23A (which is now on top) preferably is at the same level as the rear surface of inwardly extending portion 15B.

In the current embodiment, the bottom edges of honeycomb structure 23A are attached with glue to rearmost sheet 22C. However, because honeycomb structure 23A is made of relatively thin strips of cardboard that are largely separated from each other by relatively large cells, such bonding generally does not significantly restrict the movement of rearmost sheet 22C in response to the impact of a bullet. Also, in the current embodiment, at least one of the sheets 22 of woven high-strength pliable fabric (i.e., middle sheet 22B) is completely unattached to its adjacent layers and/or components.

Next, glue is applied to the rearmost surface (currently, the upwardly facing surface) of inwardly extending portion 15B, and protective panel 24 is placed within the rear (currently upwardly facing) peripheral rabbet formed by outer portion 15A and inwardly extending portion 15B on the rear (or protected) side 18 of frame 15, thereby bonding protective panel 24 into place. Preferably, the peripheral edge of protective panel 24 is tapped or pounded with a hammer to ensure it is seated properly on top of the glued surface of the rear peripheral rabbet. At this point, the rear (currently top) surface of the protective panel 24 preferably is flush with the rear (currently top) surface of the outer portion 15A of frame 15.

The entire current structure of door 10 is then placed in a press which applies approximately about 12 pounds per square inch of pressure to the front and rear surfaces of the structure for approximately 1-2 hours, while the glue cures. Generally speaking, the curing time is shorter at higher temperatures (e.g., one hour typically being sufficient at 72° F.).

Screws 49 are then inserted around the periphery of the rear (or protected) side 18 of the door 10 in order to further secure protective panel 24 to the rear surface of inwardly extending portion 15B. In the current embodiment, #8 × 1 ¼ inch screws are used, and they are placed around the entire periphery, or almost the entire periphery of door 10, at intervals of not more than 6-12 inches, and more preferably not more than 9 inches, between adjacent screws 49 on average. For this purpose, at least 30-35 screws 49 preferably are used.

Finally: (1) a groove 50 is cut into the bottom of the door 10 (matching the dimensions of bullet-resistant elongated strip 48), and the strip 48 is bonded into it, so that the bottom of strip 48 is flush with the bottom surface of the bottom rail 32 of outer portion 15A; (2) the front and rear skins 52 and 53, respectively, are attached; and (3) the door 10 is reduced to the desired size by removing the appropriate amount of wood from its edges. With respect to step (2), in the current embodiment, the unfinished door 10 is run through a glue spreader, which applies glue to both sides of the door 10 and then the skins 52 and 53 are attached.

### Additional Considerations

As used herein, the term “attached”, or any other form of the word, without further modification, is intended to mean directly attached, attached through one or more other intermediate elements or components, or integrally formed together. In the drawings and/or the discussion, where two individual components or elements are shown and/or discussed as being directly attached to each other, such attachments should be understood as being merely exemplary, and in alternate embodiments the attachment instead may include additional components or elements between such two components. Similarly, assembly, production or other steps discussed and/or claimed herein are not intended to be exclusive; rather, intermediate steps may be performed between any two steps expressly discussed or claimed herein.

Unless otherwise clearly stated herein, all relative directions (e.g., left, right, top, bottom, above, below) mentioned herein in relation to an article are from the perspective of the article itself and, therefore, are consistent across different views.

Whenever a specific value is mentioned herein, such a reference is intended to include that specific value or substantially that value, thereby encompassing values that are not substantially different from the stated value, i.e., permitting deviations that would not have substantial impact within the identified context. For example, the identification of a single length, width, depth, thickness, etc. should be understood to include values within a range around such specifically stated value that produce substantially the same effect as the specifically stated value.

In the event of any conflict or inconsistency between the disclosure explicitly set forth herein or in the accompanying drawings, on the one hand, and any materials incorporated by reference herein (whether explicitly or by operation of any applicable law, regulation or rule), on the other, the present disclosure shall take precedence. In the event of any conflict or inconsistency between the disclosures of any applications or patents incorporated by reference herein, the disclosure most recently added or changed shall take precedence.

Unless clearly indicated to the contrary, words such as “optimal”, “optimize”, “maximize”, “minimize”, “best”, as well as similar words and other words and suffixes denoting comparison, in the above discussion are not used in their absolute sense. Instead, such terms ordinarily are intended to be understood in light of any other potential constraints, such as user-specified constraints and objectives, as well as cost and processing or manufacturing constraints.

In the above discussion, certain methods are explained by breaking them down into steps listed in a particular order. Similarly, certain processing is performed by showing and/or describing modules arranged in a certain order. However, it should be noted that in each such case, except to the extent clearly indicated to the contrary or mandated by practical considerations (such as where the results from one step are necessary to perform another), the indicated order is not critical but, instead, that the described steps and/or modules can be reordered and/or two or more of such steps (or the processing within two or more of such modules) can be performed concurrently.

References herein to a “criterion”, “multiple criteria”, “condition”, “conditions” or similar words which are intended to trigger, limit, filter or otherwise affect steps, other actions, the subjects of steps or actions, or any other activity or results, are intended to mean “one or more”, irrespective of whether the singular or the plural form has been used. For instance, any criterion or condition can include any combination (e.g., Boolean combination) of actions, events and/or occurrences (i.e., a multi-part criterion or condition).

Similarly, in the discussion above, functionality sometimes is ascribed to a particular component. However, in alternate embodiments such functionality generally may be redistributed as desired among any different modules or components, in some cases completely obviating the need for a particular component and/or requiring the addition of new components. The precise distribution of functionality preferably is made according to known engineering tradeoffs, with reference to the specific embodiment of the invention, as will be understood by those skilled in the art.

As used herein, the words “include”, “includes”, “including”, and all other forms of the word should not be understood as limiting, but rather any specific items following such words should be understood as being merely exemplary.

Several different embodiments of the present invention are described above and/or in any documents incorporated by reference herein, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the intent and the scope of the invention. Accordingly, the invention is not limited to the precise embodiments shown in the drawings and described above. Rather, it is intended that all such variations not departing from the intent of the invention are to be considered as within the scope thereof, as limited solely by the claims appended hereto.

What is claimed is:

1. A bullet-resistant door, comprising:
(a) a wooden frame forming a perimeter structure;
(b) a plurality of protective layers that are collectively secured within said wooden frame and that include:
(i) plural bullet-resistant panels made of a base material that has embedded fibrous material, said bullet-resistant panels being at least semi-rigid, and
(ii) plural bullet-resistant sheets of a woven high-strength pliable fabric; and
(c) a substantially hollow core that is at least ½ inch thick and is disposed between said protective layers.

2. A bullet-resistant door according to claim 1, wherein said bullet-resistant panels comprise woven fiberglass.

3. A bullet-resistant door according to claim 1, wherein said base material comprises thermoset resin.

4. A bullet-resistant door according to claim 1, wherein said woven high-strength pliable fabric comprises fibers made of a synthetic aromatic polyamide polymer.

5. A bullet-resistant door according to claim 1, wherein said woven high-strength pliable fabric comprises fibers made of poly-para-phenylene terephthalamide.

6. A bullet-resistant door according to claim 1, wherein said protective layers comprise, from front to rear: a first one of said plural bullet-resistant panels, said plural bullet-resistant sheets of said woven high-strength pliable fabric, and a second one of said plural bullet-resistant panels.

7. A bullet-resistant door according to claim 1, wherein said wooden frame includes a thicker outer portion and a thinner inwardly extending portion.

8. A bullet-resistant door according to claim 7, wherein a first one of said plural bullet-resistant panels is attached to a first side of said thinner inwardly extending portion, and a second one of said plural bullet-resistant panels is attached to a second side of said thinner inwardly extending portion, said first and second sides being opposite sides of said thinner inwardly extending portion.

9. A bullet-resistant door according to claim 8, wherein said thinner inwardly extending portion includes an innermost edge, and wherein said substantially hollow core is interior to, and within a same depth range as, said innermost edge.

10. A bullet-resistant door according to claim 7, wherein a first one of said plural bullet-resistant panels is secured to said thinner inwardly extending portion with a plurality of screws.

11. A bullet-resistant door according to claim 10, wherein said screws are provided around the entire perimeter of said first one of said plural bullet-resistant panels, with adjacent screws being not more than 9 inches apart on average.

12. A bullet-resistant door according to claim 1, wherein at least one of said plural bullet-resistant sheets of said woven high-strength pliable fabric is held in place, across at least 75% of its surface area, solely by pressure from adjacent ones of said plurality of protective layers.

13. A bullet-resistant door according to claim 1, wherein said plural bullet-resistant sheets of said woven high-strength pliable fabric include a first one of said bullet-resistant sheets that has been bonded in place, as well as second and third ones of said bullet-resistant sheets that are held in place either solely, or almost entirely, by pressure.

14. A bullet-resistant door according to claim 1, wherein said substantially hollow core comprises a honeycomb-shaped structure.

15. A bullet-resistant door according to claim 14, wherein said honeycomb-shaped structure is comprised of at least one fiberboard or cardboard.

16. A bullet-resistant door according to claim 1, further comprising a bullet-resistant elongated strip, at least 24 inches long, that is at least semi-rigid and is embedded within a bottom segment of said wooden frame.

17. A bullet-resistant door according to claim 1, wherein said wooden frame has a maximum thickness of between 1 ½ - 2½ inches.

18. A bullet-resistant door according to claim 1, wherein said substantially hollow core is at least ¾ inch thick.

19. A bullet-resistant door according to claim 1, wherein said wooden frame has a height of at least 78 inches.

20. A bullet-resistant door according to claim 1, wherein said plural bullet-resistant panels collectively are at least 0.55 inch thick.
